(19) United States
(12) Patent Application Publication
(10) Pub. No.: US 2017/0103750 A1
(43) Pub. Date: Apr. 13, 2017

(54) Speech-based Conversion and Distribution of Textual Articles

(71) Applicant: Zinio LLC, New York, NY (US)

(72) Inventors: Korhan Bircan, San Mateo, CA (US); Denis Martin, Narragansett, RI (US)

(21) Appl. No.: 14/879,719

(22) Filed: Oct. 9, 2015

(51) Int. Cl. G10L 15/08; G06F 17/27; G10L 13/04

(52) U.S. Cl. CPC G10L 15/08; G10L 13/043; G06F 17/277; G06F 17/2705

(57) ABSTRACT

A method, comprises identifying an article embedded within a file stored in a computer-readable memory; extracting content of the article from the file; converting any non-textual portions of the content into a textual format; sending the content to a computing device that is configured to accept the content, parse the content, tokenize the content, pass tokenized content to a voice synthesizer of the mobile computing device, and audibly output the content. Devices to perform the method are also disclosed.

### TECHNOLOGICAL FIELD

The devices and methods disclosed and described below relate generally to the field of publication of electronically stored information and specifically to conversion and presentment in a speech-based format of electronically stored information to a human user.

### SUMMARY

A method can comprise identifying an article embedded within a file stored in a computer-readable memory; extracting content of the article from the file; converting any non-textual portions of the content into a textual format; sending the content to a computing device that is configured to accept the content, parse the content, tokenize the content, pass tokenized content to a voice synthesizer of the mobile computing device, and audibly output the content. The computing device can be further configured to permit selection, by a user of the computing device, of a publication source that includes at least two articles. The publication source can be one of a magazine and a newspaper.

The computing device can be further configured to permit selection, by a user of the computing device, of an article from the publication source. The computing device can be a mobile computing device. The mobile computing device can be a smartphone or a wearable computing device. The wearable computing device can be a device selected from the group consisting of a watch, an optical device, and an earpiece. The selection of a publication source can be based at least in part upon issuance of a voice command. The publication source can be one of a magazine and a newspaper. The computing device can be further configured to permit selection, by a user of the computing device, of an article from the publication source. The selection of an article from the publication source can be based at least in part upon a voice command. The computing device can be a mobile computing device. The mobile computing device can be a smartphone. Additionally or alternatively, the mobile computing device can be a wearable computing device. The wearable computing device can be a device selected from the group consisting of a watch, an optical device, and an earpiece.

A method comprises accepting, at a computing device, text-formatted content from a remote content server and extracted from an identified article embedded within a file stored in a computer-readable memory of the remote content server; parsing the content; tokenizing the content; passing tokenized content to a voice synthesizer of the mobile computing device; and audibly outputting the content. The method can further comprise the step of selecting the article and can still further comprise the step of selecting a publication source that includes at least two articles. The publication source can be one of a magazine and a newspaper. The computing device can be a mobile computing device. The mobile computing device can be a smartphone. Additionally or alternatively, the mobile computing device can be a wearable computing device. The wearable computing device can be a device selected from the group consisting of a watch, an optical device, and an earpiece.

The step of selecting the article can include accepting a voice command. The method can further comprise the step of selecting a publication source that includes at least two articles. The step of selecting a publication can include accepting a voice command. The publication source can be one of a magazine and a newspaper. The computing device can be a mobile computing device. The mobile computing device can be a smartphone. Additionally or alternatively, the mobile computing device can be a wearable computing device. The wearable computing device can be a device selected from the group consisting of a watch, an optical device, and an earpiece.

### BRIEF DESCRIPTION OF THE DRAWINGS

FIG. 1 is a system block diagram of a content conversion and distribution system.

FIG. 2 is a system block diagram of a content converter.

FIG. 3 is a flow diagram of a method of converting electronic content.

FIG. 4 is a flow diagram of a method of converting electronic content.

FIGS. 5A and 5B are plan views of a graphical user interface.

FIG. 6 is a flow diagram of a method for using voice commands.

FIG. 7 is a perspective view of computing devices.

FIG. 8 is a perspective view of machine-readable storage devices.

### DETAILED DESCRIPTION

The following detailed description will illustrate the general principles of the disclosed systems and methods, examples of which are additionally illustrated in the accompanying drawings. In the drawings, like reference numbers indicate identical or functionally similar elements. It should be noted that for clarity, brevity, and ease of reading, not every combination or subcombination of components or steps is shown or described. It will be apparent from reading this document that various other combinations, subcombinations, and modifications can be made to what is disclosed and described below without departing from the general principles of the systems and methods disclosed and described here.

Specifically, it should be noted that some components or steps shown and described as associated with a client or a server can be located on either device with no modifications or with modifications that will be apparent to those having an ordinary level of skill in this area after reading this description. Additionally, lines shown in the drawings connecting components indicate only that a connection exists and do not imply a direct connection or any specific type of connection unless further described in the description below.

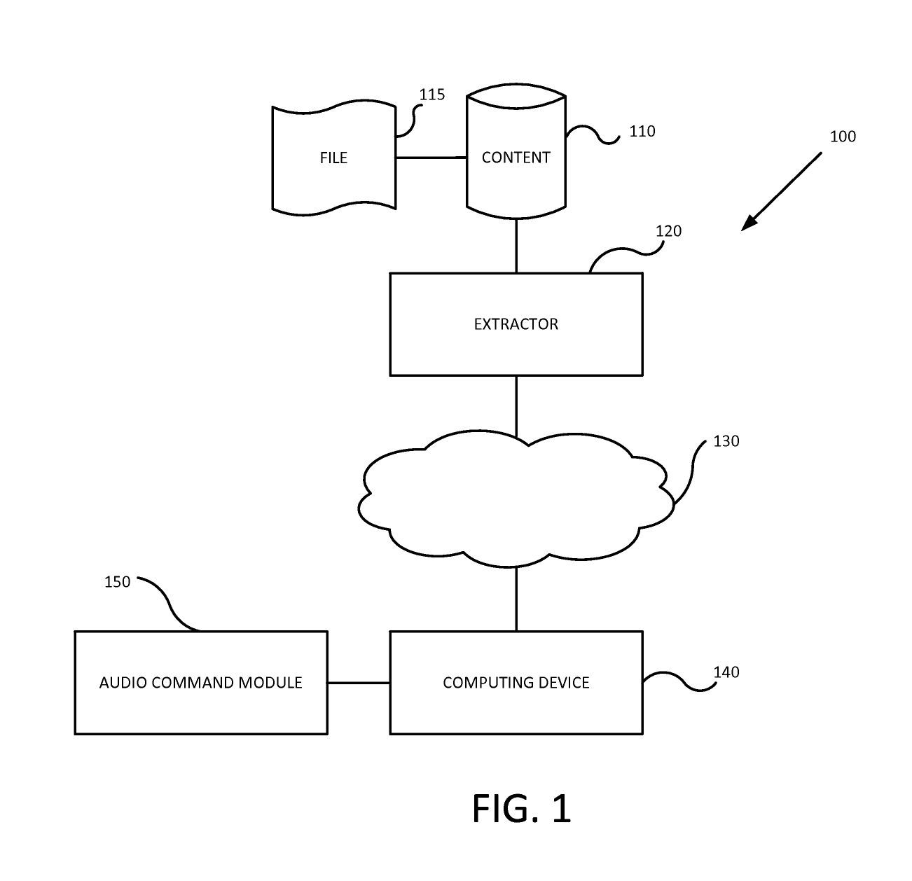

FIG. 1 is a system block diagram of a content conversion and distribution system 100. The content conversion and distribution system 100 can be used to convert electronically stored information content, such as magazine and newspaper articles, among others, to audio content and to distribute that content to a user of a computing device that is remote from the system that stores the content. A content data store 110 can store an electronically formatted file 115 that can include magazine and newspaper content. The file 115 can be in a standardized or recognized format such as PDF, JPEG, of TIFF, among others. The file 115 can include articles with text-based content, including images of text, as well as advertisements, graphs, charts, and photographs, among others.

An extractor 120 can identify article content and isolate the article content from among surrounding content. To identify an article, the extractor 120 can use content and context information of the file 115 to determine which portions of the file 115 are part of the article. Such content and context information can include known information about page layouts, color information, text information such as “continued on page . . . ” indicators, and other suitable information that can be used to separate the content of the article from surrounding non-article content.

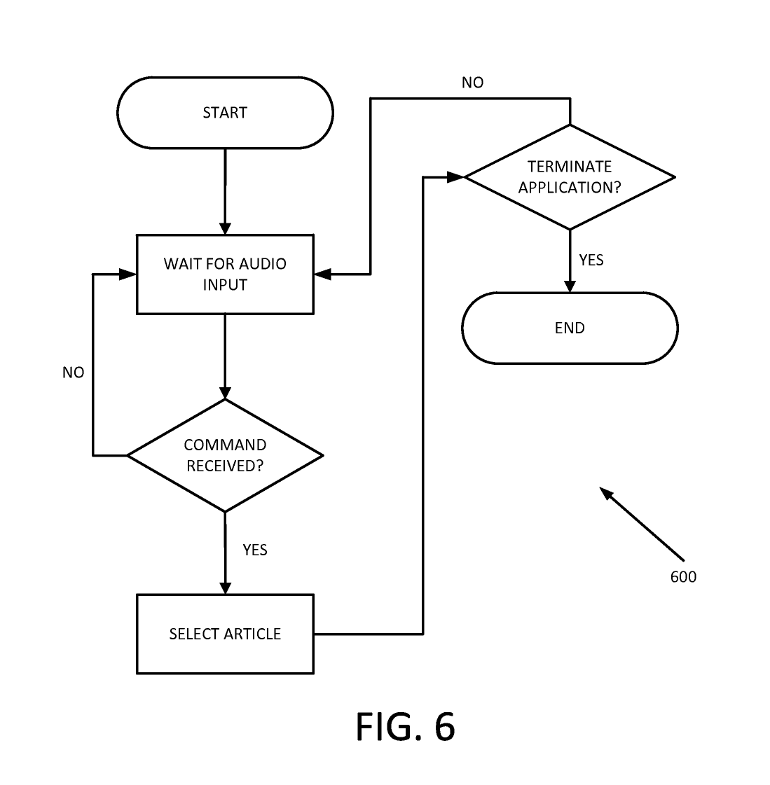

The extractor 120 can send the article over a network 130 to a computing device 140. The network 130 can be a private or public network or internetwork, the Internet, or a combination of these. The computing device 140 can be a stationary or mobile computing device or a wearable device, as described in more detail below with reference to FIG. 6.

An audio command module 150 can serve as a speech-based human-computer interface between a human user and the computing device 140. Specifically, the audio command module 150 can accept an audio or speech command to perform a function, process the accepted audio input to recognize one or more words that are indicative of one or more commands to initiate execution of a function capable of being performed by the computing device 140, and initiate execution of the function by the computing device 140. A function that can be initiated in this manner can include launching or terminating execution of an application, navigating through an application, and directing execution of an application, among others.

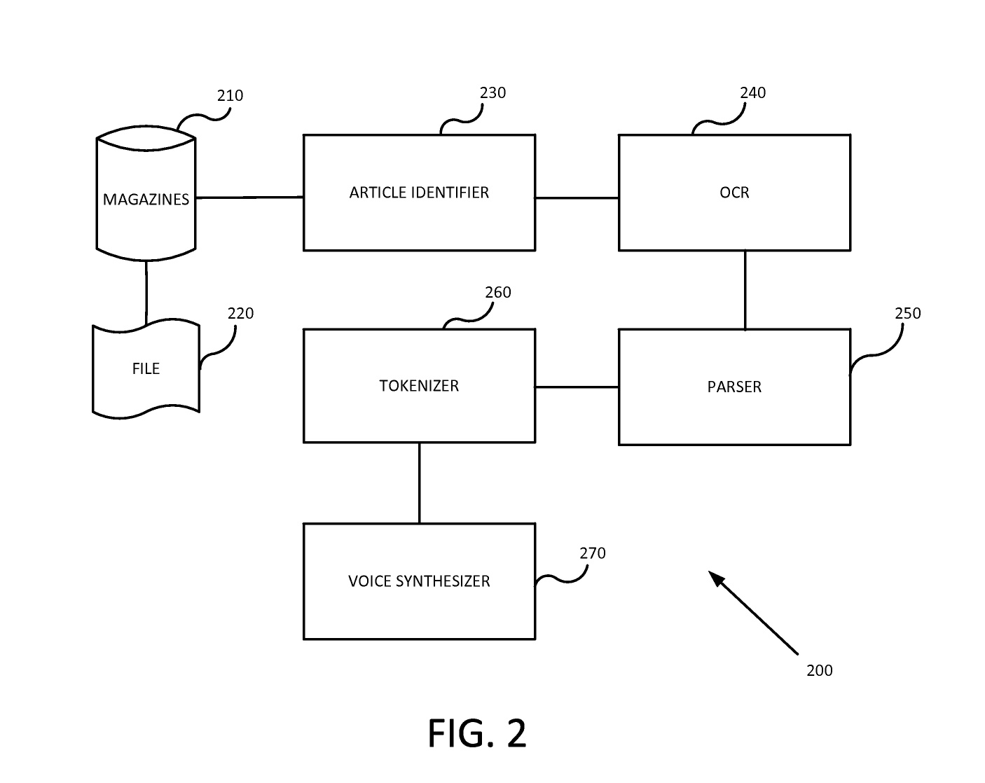

FIG. 2 is a system block diagram of a content converter 200. The content converter 200 can include a content data store 210 that can store electronically formatted information such as a file 220. An article identifier 230 can process the file 220 from the content data store 210 to identify portions of the file 220 that comprise an article and extract those portions from surrounding content. The article identifier can also determine whether the extracted portions are in a text format, such as ASCII, UTF-8, or other text encoding, or whether the extracted portions are in another format, such as an image of text.

In the case where extracted content is an image of text, the article identifier 230 can pass that content to an optical character recognition (OCR) engine 240 for conversion from an image format to text. Specifically, the OCR engine 240 can convert an image of text in an file format such as JPEG or TIFF, among others, to text encoded in a format such as ASCII, UTF-8, or another suitable encoding.

A parser 250 can accept text from the OCR engine 240 and apply rules of syntax and grammar to isolate and identify words, sentences, and paragraphs, among others, as needed or desired in a specific implementation. The parser 250 can pass parsed text to a tokenizer 260. The tokenizer 260 can create tokens from the parsed text and pass those tokens to a voice synthesizer 270. The voice synthesizer 270 can audibly output simulated speech to a user.

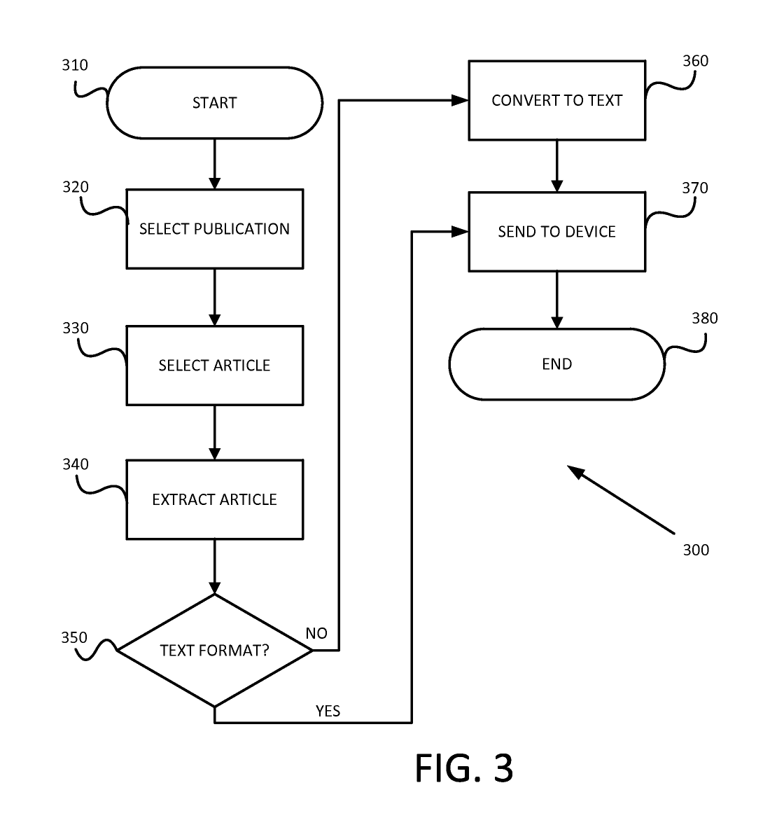

FIG. 3 is a flow diagram of a method of converting content 300. Execution of the method begins at START block 310 and continues to process block 320 where a publication is selected. The publication can be a magazine, a newspaper, or another suitable type of text-based publication. An article from the selected publication is selected at process block 330.

Execution continues at process block 340 where the selected article is extracted from any surrounding content, such as advertisements or even other articles. At decision block 350, a determination is made whether the article is in a text-based format. If that determination is NO, processing continues to process block 360 where the article is converted to a text format. Processing then continues to process block 370.

If the determination made at decision block 350 is YES, processing continues to process block 370. At process block 370, the converted text is sent to a computing device. Processing concludes at END block 380

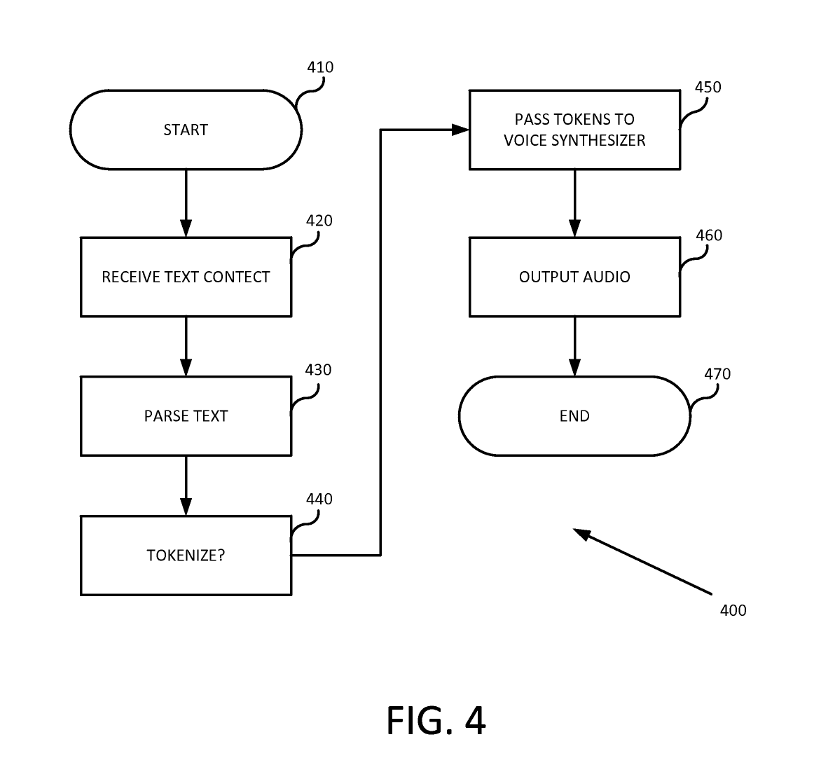

FIG. 4 is a flow diagram of a method of converting content 400. Execution of the method 400 begins at START block 410 and continues to process block 420. At process block 420, text content is received by a computing device. Processing continues to process block 430 where the received text content is parsed to identify words and sentences, among other structures. At process block 440, the parsed text is tokenized to create computer-recognizable tokens.

Processing continues to process block 450 where tokens are passed to a voice synthesizer. At process block 460, the voice synthesizer outputs audio created from the tokens. Processing concludes at END block 470.

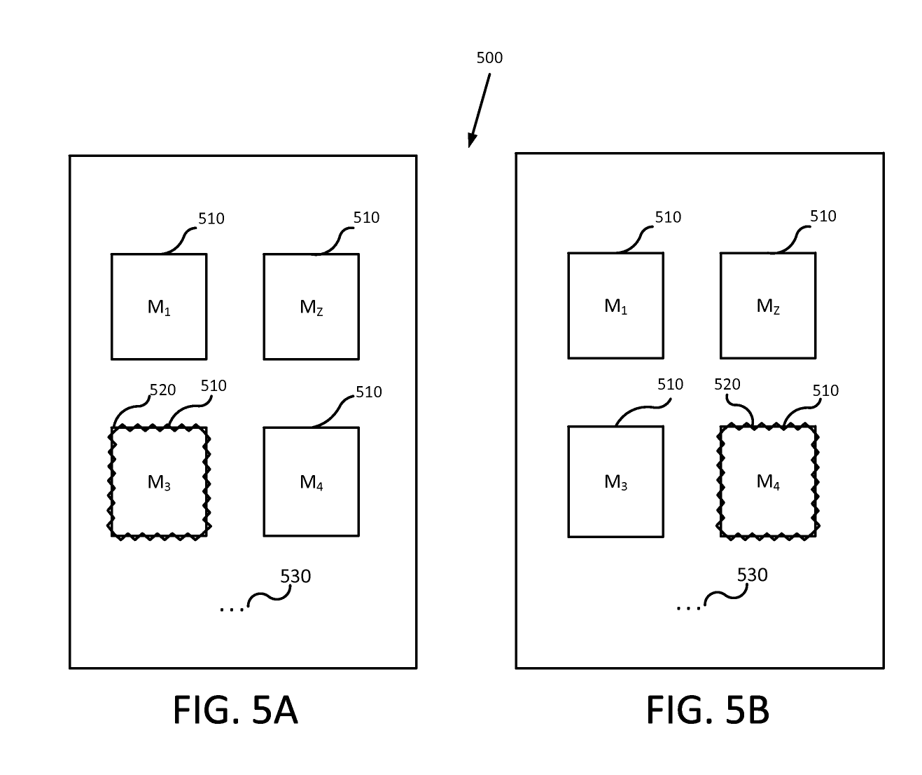

FIG. 5A is a plan view of a graphical user interface (GUI) 500. The GUI 500 can include a set of icons 510. In this example, each icon 510 represents content of a magazine that includes one or more articles. For simplicity of illustration, different magazines are illustrated simply by labeling with subscripts, M₁, M₂, M₃, and M₄, for example. An ellipsis 530 indicates that more icons can be included and may be accessed by scrolling or swiping, for example.

The GUI 500 can be activated by a voice command such as “LAUNCH,” “OPEN,” or another suitable command. Within the GUI 500, an icon can be indicated as selected, such as with highlighting 520, to indicate where focus resides. Additionally or alternatively, focus can be moved through an appropriate voice command such as “NEXT,” “PREVIOUS,” “LEFT,” “RIGHT,” “UP,” or “DOWN,” among others. FIG. 5B depicts the GUI 500 with focus changed from icon 501 labeled M₃ to icon 510 labeled M₄ and indicated as such by highlighting 520.

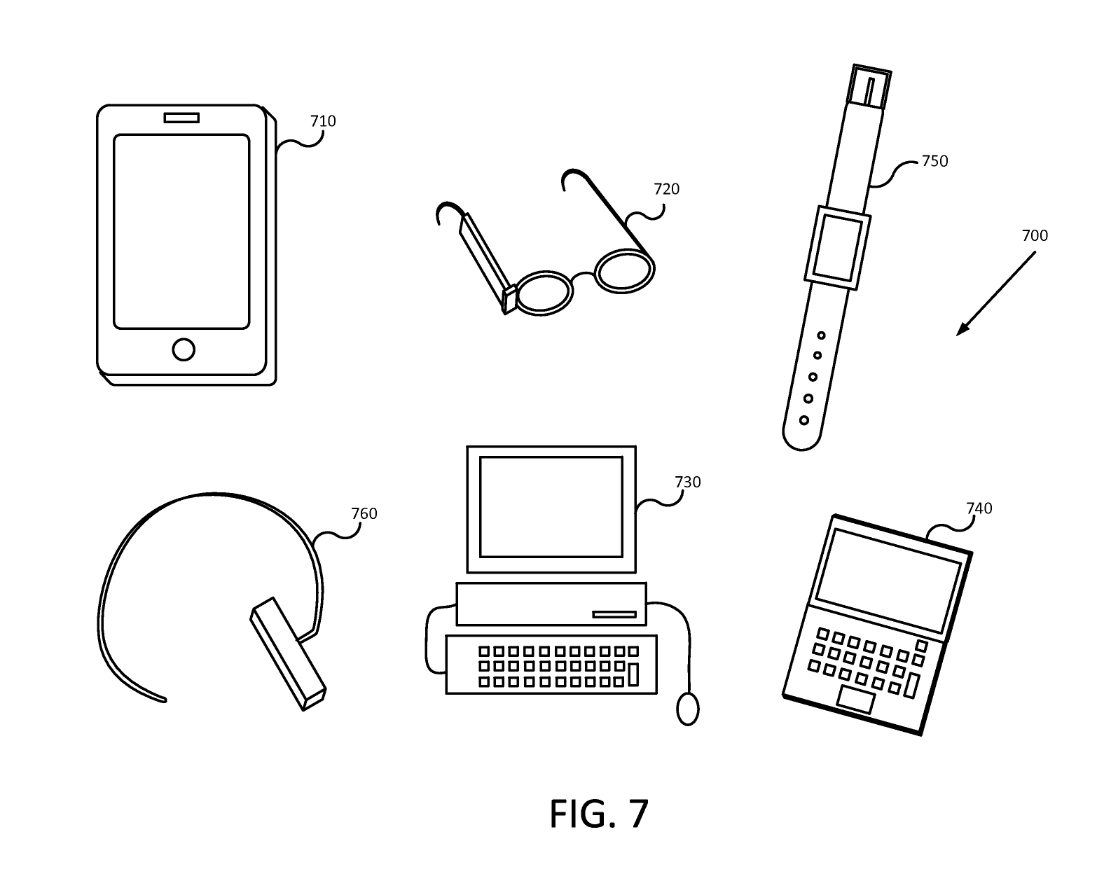

FIG. 7 is a perspective view of examples of computing devices. Each of these devices can include a processor, volatile and non-volatile memory, and visual and audio input and output devices, arranged in a specified architecture to create an operative computing device. Specifics of included components can and likely will vary according to specifics of the computing device used. Among the computing devices with which the systems and methods described above can be used are a smartphone 710, smart eyeglasses 720, a smartwatch 750, a personal computer 730, a laptop computer 740, and an earpiece 760. Each of these devices can run appropriate software to implement portions of the components and methods disclosed and described above.

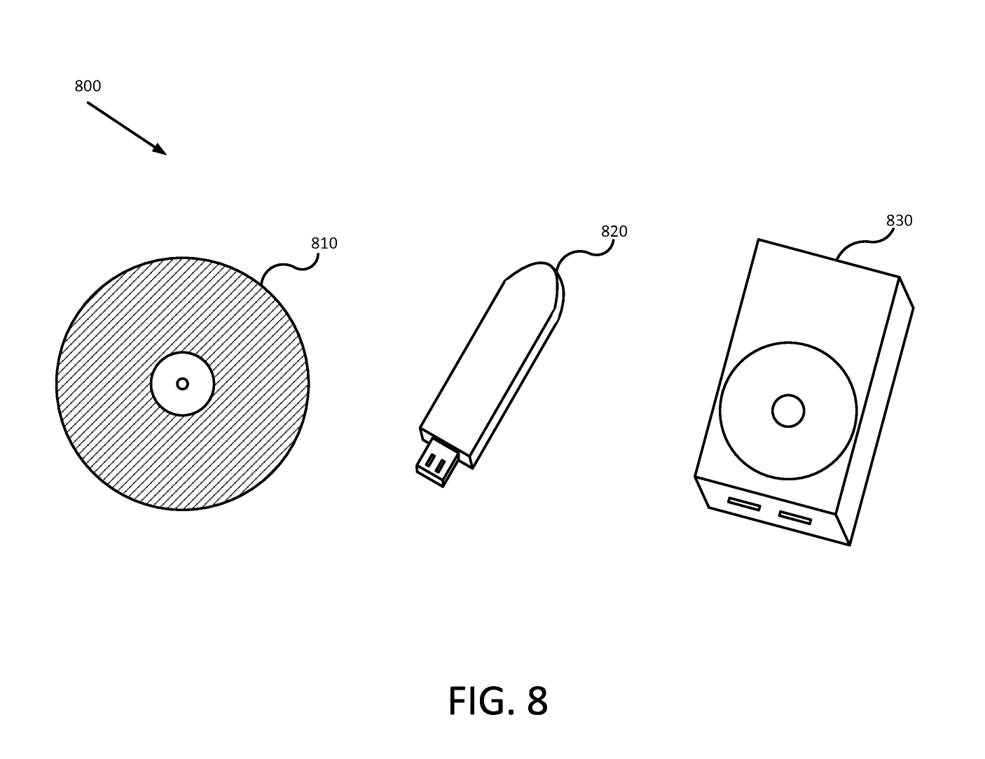

FIG. 8 is a perspective view of various computer-readable media. Program information for a computer-executable program to perform the methods discussed above can be stored and retrieved using an optical disk 810, a flash drive 820, or a hard disk drive 830. These devices can also be used to store content.

The examples of the apparatuses and methods shown in the drawings and described above are only some of numerous other examples that may be made within the scope of the appended claims. It is contemplated that numerous other configurations of the apparatuses and methods disclosed and described above can be created taking advantage of the disclosed approach. In short, it is the applicant's intention that the scope of the patent issuing from this application be limited only by the scope of the appended claims.

What is claimed is:

1. A method, comprising:
identifying an article embedded within a file stored in a computer-readable memory;
extracting content of the article from the file;
converting any non-textual portions of the content into a textual format;
sending the content to a computing device that is configured to
accept the content,
parse the content,
tokenize the content,
pass tokenized content to a voice synthesizer of the mobile computing device, and
audibly output the content.

2. The method of claim 1, wherein the computing device is further configured to permit selection, by a user of the computing device, of a publication source that includes at least two articles.

3. The method of claim 3, wherein the publication source is one of a magazine and a newspaper.

4. The method of claim 4, wherein the computing device is further configured to permit selection, by a user of the computing device, of an article from the publication source.

5. The method of claim 4, wherein the computing device is a mobile computing device.

6. The method of claim 5, wherein the mobile computing device is a smartphone.

7. The method of claim 5, wherein the mobile computing device is a wearable computing device.

8. The method of claim 7, wherein the wearable computing device is a device selected from the group consisting of a watch, an optical device, and an earpiece.

9. The method of claim 2 wherein the selection of a publication source is based at least in part upon issuance of a voice command.

10. The method of claim 9, wherein the publication source is one of a magazine and a newspaper.

11. The method of claim 10, wherein the computing device is further configured to permit selection, by a user of the computing device, of an article from the publication source.

12. The method of claim 11, wherein the selection of an article from the publication source is based at least in part upon a voice command.

13. The method of claim 12, wherein the computing device is a mobile computing device.

14. The method of claim 12, wherein the mobile computing device is a smartphone.

15. The method of claim 12, wherein the mobile computing device is a wearable computing device.

16. The method of claim 15, wherein the wearable computing device is a device selected from the group consisting of a watch, an optical device, and an earpiece.

17. A method, comprising:
accepting, at a computing device, text-formatted content from a remote content server and extracted from an identified article embedded within a file stored in a computer-readable memory of the remote content server;
parsing the content;
tokenizing the content;
passing tokenized content to a voice synthesizer of the mobile computing device; and
audibly outputting the content.

18. The method of claim 17, further comprising the step of selecting the article.

19. The method of claim 18, further comprising the step of selecting a publication source that includes at least two articles.

20. The method of claim 19, wherein the publication source is one of a magazine and a newspaper.

21. The method of claim 20, wherein the computing device is a mobile computing device.

22. The method of claim 21, wherein the mobile computing device is a smartphone.

23. The method of claim 21, wherein the mobile computing device is a wearable computing device.

24. The method of claim 23, wherein the wearable computing device is a device selected from the group consisting of a watch, an optical device, and an earpiece.

25. The method of claim 17, wherein the step of selecting the article includes accepting a voice command.

26. The method of claim 25, further comprising the step of selecting a publication source that includes at least two articles.

27. The method of claim 26, wherein the step of selecting a publication includes accepting a voice command.

28. The method of claim 27, wherein the publication source is one of a magazine and a newspaper.

29. The method of claim 28, wherein the computing device is a mobile computing device.

30. The method of claim 29, wherein the mobile computing device is a smartphone.

31. The method of claim 29, wherein the mobile computing device is a wearable computing device.

32. The method of claim 31, wherein the wearable computing device is a device selected from the group consisting of a watch, an optical device, and an earpiece.
